(19) United States
(12) Patent Application Publication
(10) Pub. No.: US 2025/0341940 A1
(43) Pub. Date: Nov. 6, 2025

(54) VIRTUAL CHARACTER MESSAGE DELIVERY IN VIRTUAL SCENES

(71) Applicant: Tencent Technology (Shenzhen) Company Limited, Shenzhen (CN)

(72) Inventor: Teng CHEN, Shenzhen (CN)

(73) Assignee: Tencent Technology (Shenzhen) Company Limited, Shenzhen, GD (CN)

(21) Appl. No.: 19/267,399

(22) Filed: Jul. 11, 2025

Related U.S. Application Data
(63) Continuation of application No. PCT/CN2024/081234, filed on Mar. 12, 2024.

(30) Foreign Application Priority Data
May 12, 2023 (CN) 202310534386.3

(51) Int. Cl. G06F 3/04815; G06T 13/40

(52) U.S. Cl. CPC G06F 3/04815; G06T 13/40

(57) ABSTRACT

In an information transmission method, a display interface of a virtual scene is displayed. The virtual scene includes a first virtual character. The first virtual character corresponds to a first user account. A second virtual character is controlled to move toward the first virtual character in the virtual scene to send first information to the first virtual character. The second virtual character corresponds to a second user account. Based on the second virtual character entering a first region in which the first virtual character is located, a first action animation of the second virtual character sending the first information to the first virtual character is displayed, and preview information of the first information is displayed.

### RELATED APPLICATIONS

The present application is a continuation of International Application No. PCT/CN2024/081234, filed on Mar. 12, 2024, which claims priority to Chinese Patent Application No. 202310534386.3, filed on May 12, 2023. The entire disclosures of the prior applications are hereby incorporated by reference.

### FIELD OF THE TECHNOLOGY

This application relates to the field of computer and Internet technologies, including an information transmission method.

### BACKGROUND OF THE DISCLOSURE

In a virtual scene provided by some applications, a virtual character of a user is a projection of the user, and represents the user in the virtual scene. Each user has a respective virtual character, and the virtual characters may interact with each other, such as moving, chatting, reading, or playing games.

In related art, an information transmission method is provided, where an information control is displayed in a display interface for displaying the virtual scene. When the user receives new information, a display style of the information control is changed to alert the user that the new information has been received. For example, the information control displays the count of unread messages. For another example, the information control starts blinking. If the user intends to view the content of the new information, the user needs to click on the information control to enter a viewing interface of the new information.

However, in related art, the information viewing operation is complex, resulting in low efficiency of viewing the content of the new information by the user.

### SUMMARY

Aspects of this disclosure provide an information transmission method, an apparatus, and a non-transitory computer-readable storage medium.

Examples of technical solutions of this disclosure may be implemented as follows:

An aspect of this disclosure provides an information transmission method. A display interface of a virtual scene is displayed. The virtual scene includes a first virtual character. The first virtual character corresponds to a first user account. A second virtual character is controlled to move toward the first virtual character in the virtual scene to send first information to the first virtual character. The second virtual character corresponds to a second user account. Based on the second virtual character entering a first region in which the first virtual character is located, a first action animation of the second virtual character sending the first information to the first virtual character is displayed, and preview information of the first information is displayed.

An aspect of this disclosure provides an information processing apparatus, including processing circuitry. The processing circuitry is configured to display a display interface of a virtual scene. The virtual scene includes a first virtual character. The first virtual character corresponds to a first user account. The processing circuitry is configured to control a second virtual character to move toward the first virtual character in the virtual scene to send first information to the first virtual character. The second virtual character corresponds to a second user account. Based on the second virtual character entering a first region in which the first virtual character is located, the processing circuitry is configured to display (i) a first action animation of the second virtual character sending the first information to the first virtual character, and (ii) preview information of the first information.

Aspects of this disclosure include an information transmission method. The method is performed by a terminal device and includes: displaying a display interface of a virtual scene in which a first virtual character is located, the virtual scene including the first virtual character and at least one another virtual character, and the first virtual character corresponding to a first user account; in a case that the first user account receives first information from a second user account, controlling a second virtual character to move toward the first virtual character in the virtual scene, the second virtual character corresponding to the second user account; and in a case that the second virtual character moves to a first region in which the first virtual character is located, displaying an action animation of the second virtual character transmitting the first information to the first virtual character, and displaying preview information of the first information.

Aspects of this disclosure include an information transmission apparatus. The apparatus includes: a first display module, configured to display a display interface of a virtual scene in which a first virtual character is located, the virtual scene including the first virtual character and at least one another virtual character, and the first virtual character corresponding to a first user account; a control module, configured to: in a case that the first user account receives first information from a second user account, control a second virtual character to move toward the first virtual character in the virtual scene, the second virtual character corresponding to the second user account; and a second display module, configured to: in a case that the second virtual character moves to a first region in which the first virtual character is located, display an action animation of the second virtual character transmitting the first information to the first virtual character, and display preview information of the first information.

Aspects of this disclosure include a terminal device. The terminal device includes a processor and a memory, the memory having a computer program stored therein, and the processor being configured to execute the computer program to implement the foregoing information transmission method.

Aspects of this disclosure include a non-transitory computer-readable storage medium. The computer-readable storage medium has computer-executable instructions stored therein, the computer-executable instructions, when executed by a processor, cause the processor to implement the foregoing information transmission method.

Aspects of this disclosure include a computer program product. The computer program product includes a computer program, the computer program being loaded and executed by a processor to implement the foregoing information transmission method.

Aspects of this disclosure have the following beneficial effects: In a case that the first user account receives the first information from the second user account, the action animation of the second virtual character transmitting the first information to the first virtual character and the preview information of the first information are displayed in the display interface of the virtual scene, so that a user can determine the content of new information according to the preview information without performing other operations, thereby improving the efficiency of viewing the new information.

In addition, in a case of processing information in a virtual world, information transmission between user accounts is simulated through virtual characters, so that the real world and the virtual world are more closely and naturally integrated, providing the user with a more interesting and realistic information processing experience. This can stimulate the user's interest in transmitting information, thereby improving the use frequency of the application, increasing the user retention in the virtual world, and further improving the user stickiness to the application. Moreover, this enables the virtual characters to have an information transmission function, thereby enriching the capabilities of the virtual characters and improving the utilization of the virtual characters.

### BRIEF DESCRIPTION OF THE DRAWINGS

FIG. 1 is a schematic diagram of a solution implementation environment according to an aspect of this disclosure.

FIG. 2 is a schematic diagram of an information transmission method according to the related art.

FIG. 3 is a schematic diagram of an information transmission method according to an aspect of this disclosure.

FIG. 4 is a flowchart of an information transmission method according to an aspect of this disclosure.

FIG. 5 is a schematic diagram of a movement manner of a second virtual character according to an aspect of this disclosure.

FIG. 6 is a schematic diagram of a movement manner of a second virtual character according to another aspect of this disclosure.

FIG. 7 is a schematic diagram of viewing first information according to an aspect of this disclosure.

FIG. 8 is a schematic diagram of marking first information as a read state according to an aspect of this disclosure.

FIG. 9 is a schematic diagram of marking first information as an unread state according to an aspect of this disclosure.

FIG. 10 is a flowchart of an information transmission method according to another aspect of this disclosure.

FIG. 11 is a flowchart of an information transmission method according to another aspect of this disclosure.

FIG. 12 is a block diagram of an information transmission apparatus according to an aspect of this disclosure.

FIG. 13 is a block diagram of an information transmission apparatus according to another aspect of this disclosure.

FIG. 14 is a structural block diagram of a terminal device according to an aspect of this disclosure.

### DETAILED DESCRIPTION

To make objectives, technical solutions, and advantages of this disclosure clearer, this disclosure is to be described in further detail with reference to the accompanying drawings. Further, the descriptions of the terms are provided as examples only and are not intended to limit the scope of the disclosure.

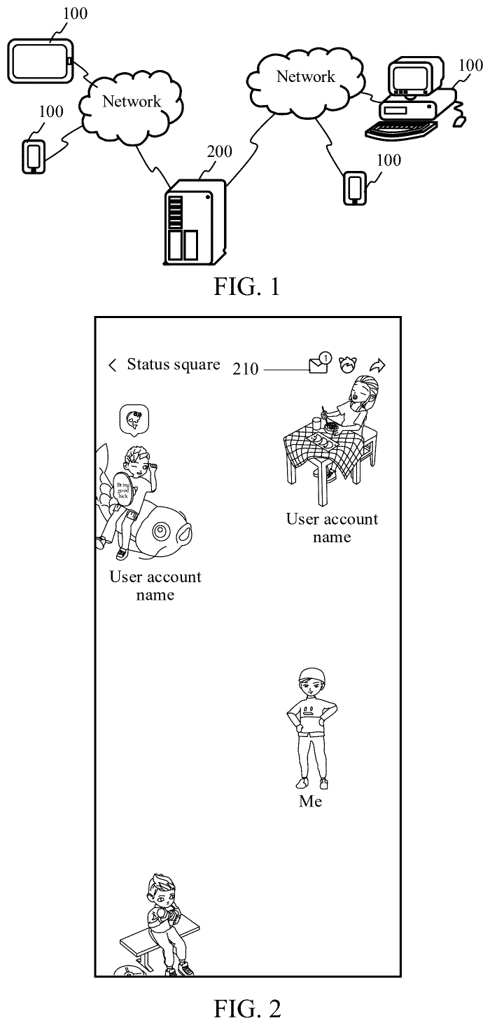

FIG. 1 is a schematic diagram of a solution implementation environment according to an aspect of this disclosure. The solution implementation environment may be implemented as an architecture of an information transmission system. The solution implementation environment may include: a terminal device 100 and a server 200.

The terminal device 100 may be an electronic device such as a personal computer (PC), a tablet computer, a mobile phone, a wearable device, an in-vehicle terminal, or the like. The terminal device 100 may be installed with a client running a first application. The first application may be a social application, or may be another application that provides a virtual scene in which a virtual character is located, such as a live streaming application, a learning application, a shopping application, a game application, or a simulation application. This is not limited in this disclosure. For example, the first application is the social application, and the first application provides the virtual scene in which the virtual character is located. For example, in a case that a first user account receives first information from a second user account, a client of the first application displays an action animation of a second virtual character transmitting the first information to a first virtual character in the virtual scene. The first virtual character corresponds to the first user account, the second virtual character corresponds to the second user account, and the first user account is different from the second user account. In addition, a form of the first application is not limited in this disclosure, including, but is not limited to, an application (App), a mini-program, and the like installed in the terminal device 100, or may be a webpage form.

In some aspects, the information transmission system may include a plurality of terminal devices 100. Each terminal device 100 may be installed with the client running the first application. The clients may be logged in by different user accounts, and information may be transmitted between different user accounts through the client.

The server 200 may be an independent physical server, or may be a server cluster including a plurality of physical servers or a distributed system, or may be a cloud server that provides a cloud computing service. The server 200 may be a backend server of the first application, and is configured to provide a backend service to the client of the first application.

The terminal device 100 may communicate with the server 200 through a network, for example, a wired or wireless network. Different terminal devices 100 may communicate through a network with the server 200 as a relay.

In an information transmission method provided in the aspects of this disclosure, an execution body of each operation may be the terminal device. The solution implementation environment shown in FIG. 1 is used as an example. The information transmission method may be performed by the terminal device 100. For example, the information transmission method is performed by the client running the first application that is installed in the terminal device 100.

By using the method described in the background, as shown in FIG. 2, an information control 210 (for example, an email control) is displayed in a display interface of a virtual scene in which a first virtual character is located. In a case that a first user account receives an email from another user account, a number of unread emails may be displayed on the information control 210. For example, in a case shown in FIG. 2, the first user account has one unread email.

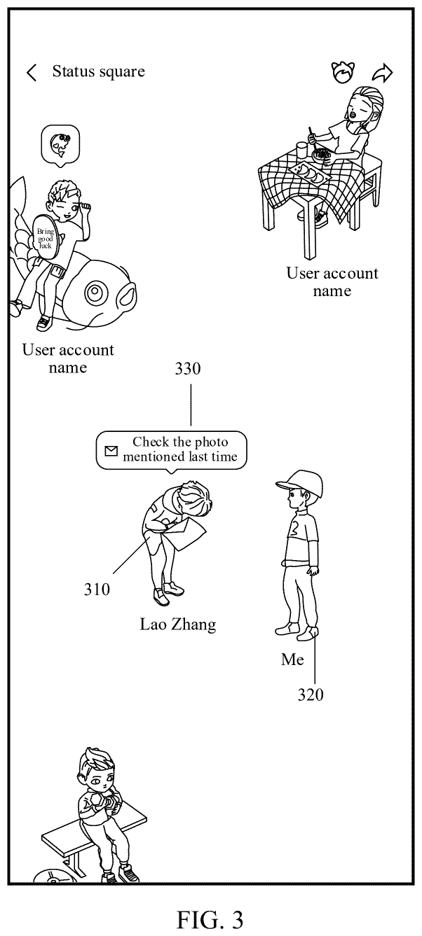

If a user intends to view the content of the unread email, the user needs to click on the information control 210 to enter a display interface of the email content. This operation is complex, resulting in low efficiency of processing new information by the user. This disclosure provides an information transmission method. As shown in FIG. 3, in a case that a first user account receives an email from a second user account, an action animation of a second virtual character 310 delivering the email to a first virtual character 320 and preview information 330 of the email are displayed, to visually alert the first user account that the email from the second user account has been received. The user can determine the content of the email according to the preview information 330 without another operation, to decide how to process the email, thereby improving the efficiency of processing the email by the user.

The technical solutions provided in the aspects of this disclosure are described below in further detail by using method aspects.

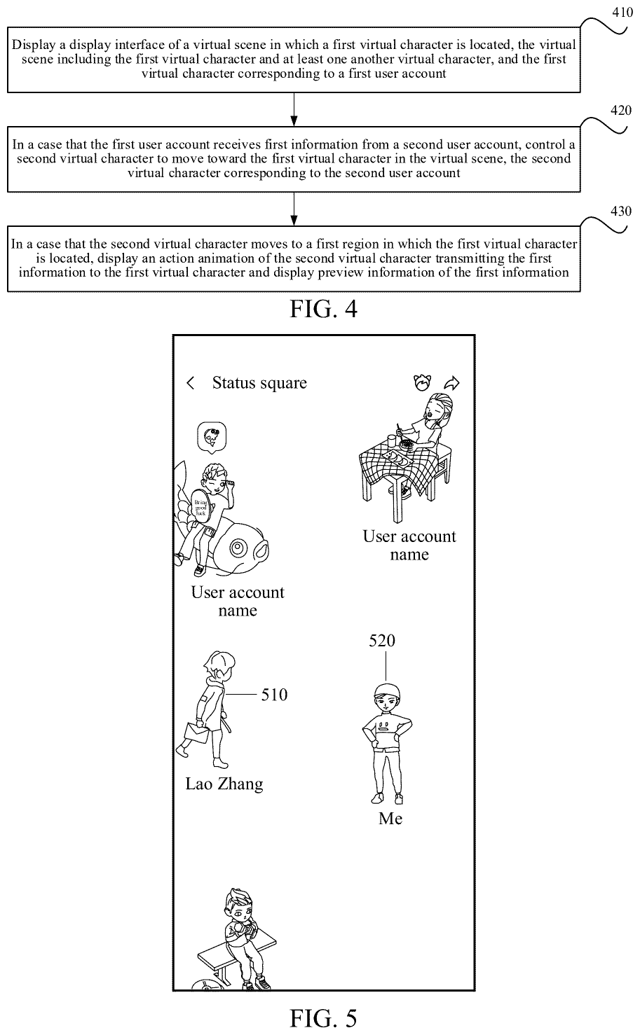

FIG. 4 is a flowchart of an information transmission method according to an aspect of this disclosure. The method may be performed by the terminal device shown in FIG. 1. For example, the terminal device is installed with the client running the first application. The method may include at least one of the following operations 410 to 430.

Operation 410: Display a display interface of a virtual scene in which a first virtual character is located, the virtual scene including the first virtual character and at least one another virtual character, and the first virtual character corresponding to a first user account. For example, a display interface of a virtual scene is displayed. The virtual scene includes a first virtual character. The first virtual character corresponds to a first user account.

The virtual scene is a scene displayed (or provided) by a client of an application (such as a social application) when running on the terminal device. The virtual scene is a scene created for virtual characters to perform activities (such as moving, chatting, playing games, and transmitting information). The virtual scene may be a simulated scene of the real world, or may be a semi-simulated and semi-fictional scene, or may be a purely fictional scene. The virtual scene may be three-dimensional, that is, a space formed by three dimensions: length, width, and height, referred to as a “three-dimensional virtual scene”; or may be two-dimensional, that is, a space formed by two dimensions: length and width, referred to as a “two-dimensional virtual scene”. This is not limited in this disclosure.

The virtual character is a character that a user account or a user controls or corresponds to in an application. For example, if the application is a social application, the virtual character is a virtual character controlled by a user account in the social application. The virtual character may be in a human form, an animal form, a cartoon form, or another form. This is not limited in this disclosure. The virtual character may also be three-dimensional, referred to as a “three-dimensional virtual character”; or may be two-dimensional, referred to as a “two-dimensional virtual character”. This is not limited in this disclosure.

In some aspects, different virtual characters correspond to different user accounts, and one virtual character uniquely corresponds to one user account. For example, the first virtual character corresponds to the first user account, the second virtual character corresponds to the second user account, and the first user account is different from the second user account. The first user account may be configured for controlling the first virtual character, and the second user account may be configured for controlling the second virtual character. For example, the first user account may interact with the second user account by controlling the first virtual character, to interact with the second virtual character.

In some aspects, the virtual scene may be a standalone virtual scene for the first virtual character. In other words, content displayed in the display interface of the virtual scene may be displayed only on a terminal device in which a client corresponding to the first user account is located, and a virtual scene displayed on a terminal device in which a client corresponding to another user account is located is different from the virtual scene. In this case, content displayed in virtual scenes corresponding to different user accounts is not shared. For example, the second virtual character is displayed in the virtual scene in which the first virtual character is located, but the second virtual character is not necessarily displayed in a virtual scene in which a third virtual character is located. The third virtual character is a virtual character different from the first virtual character and the second virtual character, and the third virtual character corresponds to a third user account.

In some aspects, the virtual scene is a multiplayer online virtual scene, that is, virtual scenes displayed on terminal devices in which clients corresponding to different user accounts are located are the same virtual scene. In this case, content displayed in a display interface that can be seen by different virtual characters in the same virtual scene is shared. For example, if the first virtual character, the second virtual character, and the third virtual character are in the same virtual scene, the third virtual character can be seen in a display interface of a virtual scene in which the first virtual character and the second virtual character are located. The first virtual character, the second virtual character, and the third virtual character are three different virtual characters.

In some aspects, the virtual scene includes the first virtual character and at least one another virtual character. The another virtual character is any virtual character other than the first virtual character in the virtual scene. In some aspects, a user account corresponding to another virtual character displayed in the virtual scene has an association relationship with the first user account. For example, another user account is a friend of the first user account, that is, the another user account has a friend relationship with the first user account. In some aspects, a user account corresponding to another virtual character displayed in the virtual scene does not have an association relationship with the first user account. For example, both the another user account and the first user account are unfamiliar accounts, that is, the another user account does not have a friend relationship with the first user account. In some aspects, a user account corresponding to another virtual character displayed in the virtual scene may have an association relationship with the first user account, or may not have an association relationship with the first user account. For example, another user account that has a friend relationship with the first user account and another user account that does not have a friend relationship with the first user account may be simultaneously displayed in the virtual scene.

In some aspects, the unfamiliar account may be provided based on a social situation of the first user account. For example, the unfamiliar account may be a user account that has accessed a social status of the first user account. The social status is content posted by the user in the first application for social interaction, for example, an update posted by the user in the first application. For another example, the unfamiliar account may be a user account corresponding to a nearby user that is determined based on an actual geographic location of a user corresponding to the first user account. This is not limited in the aspects of this disclosure.

The display interface of the virtual scene is a user interface for displaying a virtual scene, and may be configured for implementing human-computer interaction with an application, for example, obtain information related to the virtual scene or control the virtual character. The display interface may be displayed by a screen of the terminal device.

Operation 420: In a case that the first user account receives first information from a second user account, control a second virtual character to move toward the first virtual character in the virtual scene, the second virtual character corresponding to a second user account. For example, a second virtual character is controlled to move toward the first virtual character in the virtual scene to send first information to the first virtual character. The second virtual character corresponds to the second user account.

In some aspects, the first information may be information generated by the first application displaying the virtual scene, for example, the first application used by both the first user account and the second user account. The second user account may generate the first information by using the first application that is installed and runs in a second terminal device, and send the first information to the first application in the first terminal device by using a backend server corresponding to the first application. The first user account is logged in to the first application in the first terminal device.

The first information may alternatively be information generated by a second application. For example, the first user account uses the first application, and the second user account uses the second application. The second user account may generate the first information by using the second application that is installed and runs in the second terminal device, and send the first information to the first application in the first terminal device by using a backend server corresponding to the second application and the backend server corresponding to the first application. The first user account is logged in to the first application in the first terminal device. This is not limited in this disclosure.

In some aspects, the first application may have an association relationship with the second application. The association relationship may be an association relationship generated based on accounts, or may be another association relationship. For example, different cloud games in the same cloud game application have an association relationship.

In some aspects, a user account used by the first application displaying the virtual scene has an association relationship with a user account used by the second application.

For example, the first application displaying the virtual scene and the second application use the same user account. For example, the first user account may be configured for logging in to a client of the first application, and may also be configured for logging in to a client of the second application.

For example, the user account used by the first application displaying the virtual scene and the user account used by the second application are in one-to-one correspondence. For example, a user account I used by the first application displaying the virtual scene corresponds to a user account 11 used by the second application, and information received by the user account 11 used by the second application may be displayed in the virtual scene displayed by the first application.

In some aspects, each user account of the first application may correspond to a plurality of user accounts of the second applications. For example, the user account of the first application may be in one-to-one correspondence with a user account of an email application, an instant messaging application, or a game assistant application, so that the user can view information of a plurality of applications in the first application, without jumping to another application to view new information, thereby improving the efficiency of processing the new information by the user.

In some aspects, an association relationship between the user account of the first application and the user account of the second application, or whether the first application synchronizes information received by the user account of the second application is customized by the user.

For example, in response to a binding operation on the user account of the first application and the user account of the second application, information received by the user account of the second application is synchronized in the first application; and in response to an unbinding operation on the user account of the first application and a user account of a third application, information received by the user account of the third application is canceled to be synchronized in the first application. The user can independently determine whether to synchronize the information received by the user account of the second application in the first application, which helps the user to process information received by different applications more conveniently and quickly.

The binding operation is a process of establishing an association relationship between user accounts of different applications, and the unbinding operation is a process of removing the association relationship between the user accounts of different applications.

In some aspects, in a case that the user account of the first application is bound to the user account of the second application, a virtual character corresponding to another user account of the second application may also be displayed in the virtual scene. The user not only can interact socially with a virtual character corresponding to the user account of the first application in the virtual scene, but also can interact socially with a virtual character corresponding to the user account of the second application. In this way, there is no need to frequently switch different applications for social interaction, thereby improving the convenience and efficiency of social interaction, and further improving user experience.

In some aspects, the first virtual character may correspond to the first user account of the user in different applications, the first virtual character may switch the first user account corresponding to the first virtual character, and in a case that the first virtual character corresponds to the first user account of different applications, virtual characters displayed in the virtual scene are different. For example, in a case that the first virtual character corresponds to the first user account of the first application, virtual characters displayed in the virtual scene are all virtual characters corresponding to the user account of the first application, and the user can interact socially with another user of the first application in the virtual scene. In a case that the first virtual character corresponds to the first user account of the second application, virtual characters displayed in the virtual scene are all virtual characters corresponding to the user account of the second application, and the user can interact socially with another user of the second application in the virtual scene. In this way, it is beneficial to improving the versatility of the first virtual character.

In some aspects, a form displayed by the virtual character when the virtual character corresponds to the user account of the first application may be the same as or different from a form displayed by the virtual character when the virtual character corresponds to the user account of the second application.

In some aspects, the virtual character may be provided by an application and selected by a user account. For example, the first virtual character may be selected by the first user account from a plurality of virtual characters provided by the application. The virtual character may alternatively be customized by the user account. For example, the application provides a customized function of the virtual character, for example, customization of model, appearance, outfit, item, gesture, action, or the like for the virtual character. The first user account may customize the first virtual character by using the function.

For example, a form of the virtual character may be customized by the user, or may be generated according to a social status and account information of the user account. For example, the form of the virtual character may be customized by the user after the user performs an operation such as sculpting a face or changing outfits. For example, the form of the virtual character may be automatically generated according to the social status and the account information of the user account. For example, if the account information of the user account is displayed as female, 20 years old, and studying, a virtual character of the user account may be a female with a schoolgirl appearance.

In some aspects, the second virtual character may be a virtual character that exists in the virtual scene, or may be a virtual character that does not exist in the virtual scene. If the second virtual character is the virtual character that does not exist in the virtual scene, in a case that the first user account receives the first information from the second user account, the second virtual character is generated in the virtual scene, and the second virtual character is controlled to move toward the first virtual character.

A form of the first information is not limited in this disclosure. In some aspects, the first information may be information in an email form, information in a text message form, or information in a social application.

In some aspects, the first information may include at least one of the following: text information, voice information, image information, a file (or referred to as an attachment), or video information. For example, the first information may include only the text information, may include the text information and the image information, or may include the text information and the attachment.

In some aspects, a distance between the second virtual character and the first virtual character is different, and when the second virtual character moves, different movement manners may be used. The distance between the second virtual character and the first virtual character is a relative distance, such as a linear distance, between a location of the second virtual character in the virtual scene and a location of the first virtual character in the virtual scene.

In some aspects, the movement manner is related to at least one of the following: a movement speed and a movement form. Different movement manners may have different movement speeds or different movement forms. The movement form is a display style of the second virtual character during movement, and the movement speed is a speed at which the second virtual character moves in the virtual scene.

For example, movement speeds of the same movement manner may be the same or may be different. In other words, movement speeds corresponding to the same movement form may be the same or may be different. For example, different movement manners may correspond to different movement speeds and different movement forms. For example, a movement manner 1 may correspond to a movement speed 1 and a movement form 1, a movement manner 2 may correspond to a movement speed 2 and a movement form 2, the movement speed 1 is different from the movement speed 2, and the movement manner 1 is different from the movement manner 2. Different movement manners may also correspond to different movement speeds and the same movement form. For example, the movement manner 1 may correspond to the movement speed 1 and the movement form 1, and the movement manner 2 may correspond to the movement speed 2 and the movement form 1. Different movement manners may also correspond to the same movement speed and different movement forms. For example, the movement manner 1 may correspond to the movement speed 1 and the movement form 1, and the movement manner 2 may correspond to the movement speed 1 and the movement form 2. This is not limited in this disclosure. In this way, the user can quickly learn the distance between the second virtual character and the first virtual character, thereby improving the information obtaining efficiency and the fun of social interaction.

Operation 430: In a case that the second virtual character moves to a first region in which the first virtual character is located, display an action animation of the second virtual character transmitting the first information to the first virtual character, and display preview information of the first information. For example, based on the second virtual character entering a first region in which the first virtual character is located, a first action animation of the second virtual character sending the first information to the first virtual character is displayed, and preview information of the first information is displayed.

In some aspects, the action animation of the second virtual character transmitting the first information to the first virtual character is not limited in this disclosure. For example, the action animation may be an action animation of delivering a file with two hands, or may be an action animation of talking with the first virtual character.

In some aspects, for first information from different applications, the action animation of the second virtual character transmitting the first information to the first virtual character may be the same or may be different.

For example, for the first information from different applications, the action animation of the second virtual character transmitting the first information to the first virtual character may be all the action animation of delivering a file with two hands.

For another example, for first information from an application 1, the action animation of the second virtual character transmitting the first information to the first virtual character is the action animation of delivering a file with two hands; and for first information from an application 2, the action animation of the second virtual character transmitting the first information to the first virtual character is the action animation of talking with the first virtual character. In this way, the user can determine, according to an action of the virtual character, which application the first information is from, and further determine the importance of the first information, to determine a manner of processing the first information.

In some aspects, for different forms of first information, the action animation of the second virtual character transmitting the first information to the first virtual character may be the same or may be different.

For example, for first information in the email form, the action animation of the second virtual character transmitting the first information to the first virtual character may be the action animation of delivering an email with two hands.

For another example, for first information in the email form, the action animation of the second virtual character transmitting the first information to the first virtual character is the action animation of delivering an email with two hands; and for first information in the text message form, the action animation of the second virtual character transmitting the first information to the first virtual character is the action animation of talking with the first virtual character. In this way, the user can determine the form of the first information according to the action of the virtual character, and further quickly determine a manner of processing the first information.

The first region is a region configured for triggering to display the action animation, and may be set and adjusted according to an actual use requirement. In some aspects, a specific range and shape of the first region are not limited in this disclosure.

For example, the first region may be a region centered on the first virtual character. For example, the first region is a circular region centered on the first virtual character. For another example, the first region is a rectangular region centered on the first virtual character.

For example, a size of the first region may be preset by the client, or may be customized by the user according to a habit of the user. This is not limited in this disclosure.

In some aspects, the preview information of the first information is configured for prompting the content of the first information. For example, the preview information of the first information may display some or all of the content of the first information.

For example, the preview information of the first information may be some or all information captured from the first information, or may be theme information extracted according to the content of the first information. For example, the preview information of the first information may be the content of first n characters of the first information, n being an integer greater than 0. For another example, the preview information of the first information may be theme information summarized according to the content of the first information, and the theme information includes an intention of the first information.

In some aspects, a form of the preview information of the first information may change according to the form of the first information. The form of the preview information of the first information may be the same as that of the first information, or may be different from that of the first information.

For example, the form of the preview information of the first information is the same as that of the first information. If the first information is text, the preview information of the first information is also text. If the first information is image, the preview information of the first information is also image.

For example, the form of the preview information of the first information is different from the form of the first information. For example, the first information is image, and the preview information of the first information is text.

In some aspects, the form of the preview information of the first information may be fixed. For example, regardless of whether the first information is text, image, or voice, the preview information of the first information is text.

In some aspects, the preview information of the first information may be displayed around the second virtual character. For example, the preview information of the first information may be displayed above the second virtual character in a bubble form. The preview information may be prominently displayed, such as through highlighting, blinking, movement, or floating.

In some aspects, the preview information of the first information may be displayed in a fixed display region of a terminal screen. For example, the preview information of the first information is displayed in a first display region of the terminal screen. The first display region may be a preset region, or may be a region customized by the user. For example, the first display region may be a floating card interface displayed in the display interface of the virtual scene, and the user may adjust a location and a size of the card interface.

In some aspects, identification information corresponding to each virtual character is further displayed in the virtual scene, where the identification information is configured for identifying the user account corresponding to the virtual character. For example, the identification information may be a nickname of the user account corresponding to the virtual character, or may be a remark made by the user for the user account corresponding to the virtual character. In this way, the user can determine a source of the received new information.

According to the technical solutions provided in the aspects of this disclosure, in a case that the first user account receives the first information from the second user account, the action animation of the second virtual character transmitting the first information to the first virtual character and the preview information of the first information are displayed in the display interface of the virtual scene, so that the user can determine the content of the new information according to the preview information without performing other operations, thereby improving the efficiency of viewing the new information.

Further, the user can quickly determine how to process the new information (such as viewing details, ignoring, and replying) according to the preview information, thereby improving the efficiency of processing the new information by the user.

In addition, in a case of processing information in a virtual world, information transmission between user accounts is simulated through virtual characters, so that the real world and the virtual world are more closely and naturally integrated, providing the user with a more interesting and realistic information processing experience. This can stimulate the user's interest in transmitting information, thereby improving the use frequency of the application, increasing the user retention in the virtual world, and further improving the user stickiness to the application. Moreover, this enables the virtual characters to have an information transmission function, thereby enriching the capabilities of the virtual characters and improving the utilization of the virtual characters.

In some aspects, because distances between locations of different virtual characters in the virtual scene and the location of the first virtual character are different, if the different virtual characters move toward the first virtual character at the same speed, more time needs to be allocated to virtual characters that are far away during movement, which may result in a delay for the user in receiving the information. In view of this, this disclosure provides a solution as an example.

In some aspects, the foregoing operation 420 may be implemented as the following operation 421.

Operation 421: In a case that the first user account receives the first information from the second user account, control the second virtual character to move toward the first virtual character in the virtual scene in a first movement manner, the first movement manner being determined according to a distance between the second virtual character and the first virtual character.

The first movement manner is a movement manner of the second virtual character displayed in the virtual scene, and the movement manner is related to at least one of the following: a movement speed and a movement form.

In some aspects, the first movement manner may be determined by the client of the application, or may be determined by a backend server corresponding to the client. This is not limited in this disclosure.

In some aspects, a movement manner is selected from a plurality of candidate movement manners as the first movement manner according to the distance between the second virtual character and the first virtual character.

In some aspects, the first movement manner may be selected from the plurality of candidate movement manners by using a distance threshold. For example, a plurality of distance ranges may be obtained through division based on the distance threshold, where each distance range corresponds to one movement manner. If the distance between the second virtual character and the first virtual character falls within a first distance range of the plurality of distance ranges, a movement manner corresponding to the first distance range is determined as the first movement manner.

For example, it is assumed that the distance between the second virtual character and the first virtual character is D, if D<D1, the movement manner 1 is selected as the first movement manner; if D1<D<D2, the movement manner 2 is selected as the first movement manner; and if D2<D<D3, a movement manner 3 is selected as the first movement manner. D1<D2<D3, where D1, D2, and D3 are distance thresholds, and may be set and adjusted according to an empirical value.

In some aspects, different movement manners correspond to different movement speeds or different movement forms. The movement form is a display style of the second virtual character during movement.

The movement form is not limited in this disclosure. For example, the movement form may be moving by walking (such as walking and running), moving by bicycle, or moving by rocket.

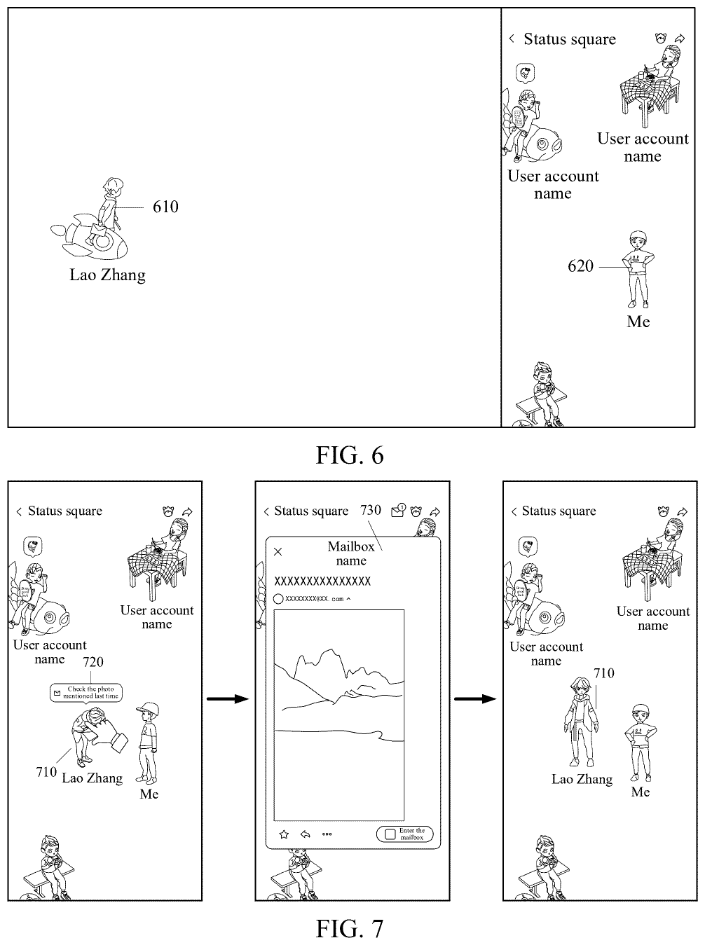

For example, as shown in FIG. 5, in a case that a distance between a second virtual character 510 and a first virtual character 520 is small, moving by walking is selected as the first movement manner. For example, as shown in FIG. 6, in a case that a distance between a second virtual character 610 and a first virtual character 620 is large, moving by rocket is selected as the first movement manner.

In some aspects, the same movement manner corresponds to the same movement speed. In other words, two different virtual characters moving in the first movement manner have the same movement speed, and the movement speed is not related to the distance between the second virtual character and the first virtual character, and is only related to the movement manner. For example, if the movement manner 1 is used, the movement speed is 10 m/s (meter per second), and if the movement manner 2 is used, the movement speed is 100 m/s.

According to the foregoing method, when the movement manner is determined, the movement speed of the virtual character is determined, and the movement speed of the virtual character does not need to be additionally calculated, thereby releasing computing power of the server.

In a case that two different virtual characters have different distances from the first virtual character but move toward the first virtual character in the same movement manner, if the movement speed is determined by using the foregoing method, even if the two different virtual characters have the same departure time, the arrival time of the two different virtual characters at the first region in which the first virtual character is located is different. This may mislead the user corresponding to the first user account in processing the new information, causing the user to misjudge the sending time of the two pieces of information, and further misjudge the urgency of the two pieces of information. For example, the user may consider that the sending time of information transmitted by a virtual character that arrives later is late, and the urgency of the information is low, allowing the information processing to be delayed. In view of this, this disclosure provides another method for determining a movement speed.

In some aspects, a time threshold may be set, and the time threshold is configured for indicating a time required for the second virtual character to move to the first region in which the first virtual character is located. A movement speed of the second virtual character is determined according to a ratio of the distance between the second virtual character and the first virtual character to the time threshold. In this way, in a case that different virtual characters start to move toward the first virtual character at different locations at the same time, the different virtual characters may also arrive at the first region in which the first virtual character is located at the same time, avoiding misunderstanding of an order of receiving information transmitted by the different virtual characters by the first user account.

In some aspects, the distance between the first virtual character and the second virtual character may be related to an actual distance between the first user account and the second user account. For example, the distance between the first virtual character and the second virtual character may be positively correlated with the actual distance between the first user account and the second user account.

The actual distance between the first user account and the second user account is a linear distance between an actual geographic location of the first user account and an actual geographic location of the second user account. The actual geographic location may be a geographic location of the user corresponding to the user account in a real environment.

For example, the actual distance between the first user account and the second user account may be determined based on a positioning system, for example, may be determined based on a global positioning system (GPS).

In some aspects, the actual distance between the first user account and the second user account may be determined based on location information provided in account information of the first user account and location information provided in account information of the second user account. The location information provided in the account information may be determined based on the positioning system, or may be customized by the user. This is not limited in this disclosure.

Different movement forms correspond to different distances between the first virtual character and the second virtual character, and the distance between the first virtual character and the second virtual character is related to the actual distance between the first user account and the second user account. The user can determine whether the information is far away or the information is nearby according to the movement form of the second virtual character, and map the actual distance to the virtual scene, to shorten a social distance between users.

In some aspects, the distance between the first virtual character and the second virtual character is determined according to locations of the first virtual character and the second virtual character in the virtual scene. In an example, if the second user account is in an online state, the distance between the first virtual character and the second virtual character may be determined by using a current location of the second virtual character. In another example, if the second user account is in an offline state, the distance between the second virtual character and the first virtual character may be determined according to a location of the second virtual character when the second virtual character is in the offline state.

According to the foregoing method, the movement manner used by the second virtual character is determined according to the distance between the second virtual character and the first virtual character. Different movement manners correspond to different movement speeds, so that the second virtual character can arrive at the first region in which the first virtual character is located in a short period of time, ensuring the timeliness of the first information received by the first user account, and integrating a process of receiving the first information is into the virtual scene, which is more interesting.

This disclosure also provides a method for how to process the first information by the first user corresponding to the first user account after the first information is received.

In some aspects, the first information is displayed in response to a first operation of viewing the first information; in response to a second operation of marking the first information as a read state, the first information is marked as the read state, and first prompt information is displayed; and the first information is marked as an unread state in response to a third operation of temporarily not processing the first information. The first prompt information is configured for indicating that the first information has been marked as the read state.

The first operation, the second operation, and the third operation may be operations on the second virtual character, or may be operations on the preview information, or may be operations on the second virtual character and the preview information. For example, the first information is displayed in response to the first operation on the second virtual character; or the first information is displayed in response to the first operation on the preview information. For another example, the first information is displayed in response to the first operation on the second virtual character or the preview information.

Specific operations of the first operation, the second operation, and the third operation are not limited in this disclosure. For example, the first operation may include at least one of the following: a click operation, a press and hold operation, a slide operation, a double-click operation, or a drag operation; the second operation may include at least one of the following: a click operation, a press and hold operation, a slide operation, a double-click operation, or a drag operation; and the third operation may include at least one of the following: a click operation, a press and hold operation, a slide operation, a double-click operation, or a drag operation. In some aspects, the operation in this disclosure may be triggered by a touch display screen of the terminal device, or may be triggered by an external device of the terminal device. This is not limited in this disclosure.

In some aspects, the first operation, the second operation, and the third operation are three different operations, so that the device can distinguish an actual operation intention of the user.

For example, the first operation is the click operation, the second operation is the press and hold operation, and the third operation is the drag operation. The first information is displayed in response to the click operation of viewing the first information; in response to the press and hold operation of marking the first information as a read state, the first information is marked as the read state, and first prompt information is displayed; and the first information is marked as an unread state in response to the drag operation of temporarily not processing the first information. The first prompt information is configured for indicating that the first information has been marked as the read state.

The read state is configured for indicating that the first information has been read, and the unread state is configured for indicating that the first information is unread and is to be read by the user.

In some aspects, in the virtual scene, the first virtual character is displayed in a first default posture, and the second virtual character is displayed in a second default posture.

The default posture may be a default display posture of the virtual character, such as standing, running, exercising, sitting, lying, reading, dining, playing games, or having classes. The first default posture and the second default posture are not limited in this disclosure. In some aspects, the first default posture may be the same as or different from the second default posture. In some aspects, the first default posture may be set by the first user account, and the second default posture may be set by the second user account. In some aspects, the first default posture and the second default posture may alternatively be preset by the client.

In some aspects, the first default posture may be set according to the account information of the first user account. For example, if the account information of the first user account shows that the user is in a withdrawn state, the first default posture may be a posture of rejecting communication. Correspondingly, the second default posture may also be set according to the account information of the second user account.

In some aspects, after the first user account processes the first information, the second virtual character changes from the action animation of the second virtual character transmitting the first information to the first virtual character to the second default posture. In this way, it is convenient for the first user account and the second user account to quickly learn whether the first information is processed, which is beneficial to promoting social progress.

For example, as shown in FIG. 7, in response to clicking on a second virtual character 710 or preview information 720, a display interface 730 of the first information is displayed, and in response to an operation of closing the display interface 730 of the first information, the second virtual character 710 restores to be displayed in the second default posture from the action animation. The display interface 730 is configured for displaying the content of the first information.

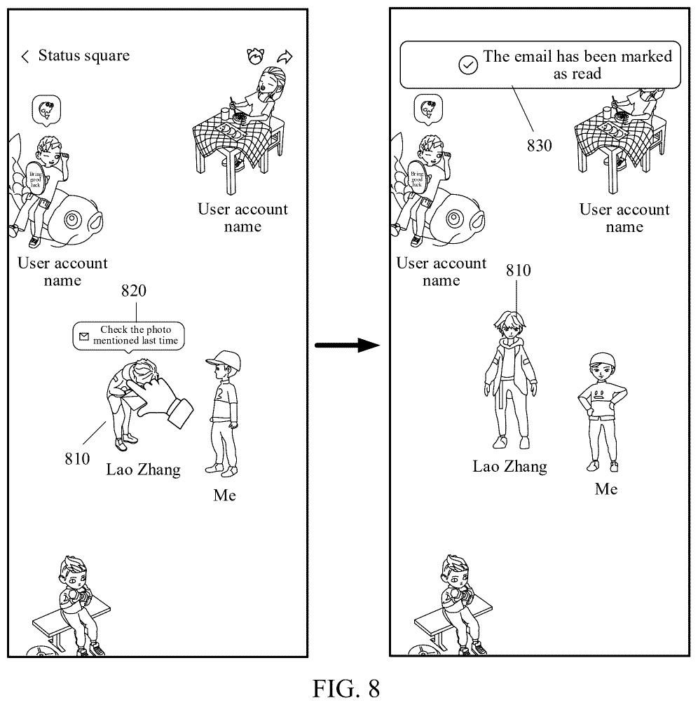

For example, as shown in FIG. 8, in response to pressing and holding a second virtual character 810 or preview information 820, the first information is marked as a read state, first prompt information 830 is displayed, and the second virtual character 810 restores to be displayed in the second default posture from the action animation.

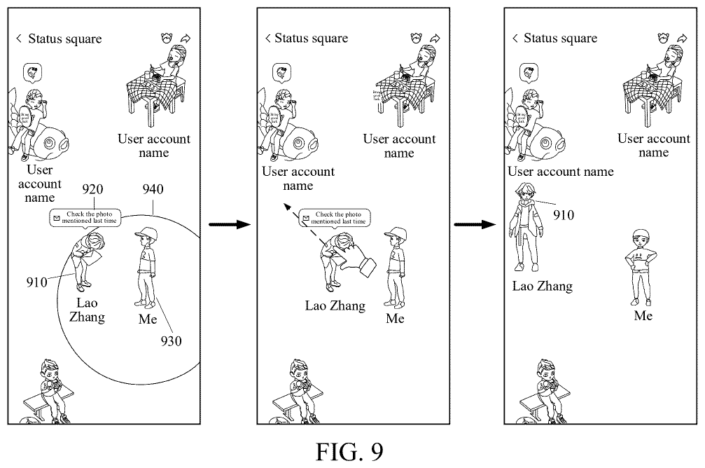

For example, as shown in FIG. 9, in response to dragging a second virtual character 910 or preview information 920 out of a first region 940 in which a first virtual character 930 is located, the first information is marked as an unread state, and the second virtual character 910 restores to be displayed in the second default posture from the action animation.

In some aspects, after the first information is processed, the second virtual character may be restored to an original location, or may stay nearby the first virtual character to wait for the first virtual character to reply information. This is not limited in this disclosure.

In some aspects, when the first user account processes the first information, the first virtual character may display a corresponding action animation according to an operation of the user. For example, the first virtual character is controlled to display a viewing pose in response to the first operation of viewing the first information. For example, an action animation of the first virtual character receiving a file from the second virtual character and opening the file for viewing is displayed. For example, the first virtual character is controlled to display a read posture in response to the second operation of marking the first information as the read state. For example, an action animation of the first virtual character nodding to the second virtual character to indicate that the first virtual character understands is displayed. For example, in response to the third operation of temporarily not processing the first information, the first virtual character is controlled to display a posture of temporarily not viewing. For example, an action animation of the first virtual character being at work is displayed.

Another processing manner for the first information, for example, replying to the first information, may also be supported in the aspects of this disclosure. An editing interface for reply information is displayed in response to a sixth operation on the second virtual character or the preview information, and the reply information is sent in response to an editing completion operation on the reply information. The sixth operation may include at least one of the following: a click operation, a double-click operation, a slide operation, or a press and hold operation. For example, special marking may further be performed on the first information, for example, adding the first information to favorites or deleting the first information.

According to the foregoing method, after the first user account receives the first information from the second user account, the first user account may process the first information in the virtual scene without entering another interface and jumping to another application, thereby simplifying the process of processing information.

In addition, information is viewed by using the click operation, the first information is marked as the read state by using the press and hold operation, and the first information is marked as the unread state by using the drag operation. An operation design and its triggered function are more in line with conventional thinking and understanding of a user, thereby reducing learning costs of the user, avoiding accidental touches to some extent, and improving user experience.

In some aspects, in a case that the first user account receives the first information from the second user account, the second virtual character corresponding to the second user account does not exist in the virtual scene. In this way, a new virtual character may be generated in the virtual scene as the second virtual character.

In some aspects, in a case that the second virtual character does not exist in the virtual scene, the second virtual character is generated at the first location in the virtual scene, and the second virtual character is controlled to move toward the first virtual character.

The first location is a predefined location or a location region in the virtual scene. In a case that the second virtual character does not exist in the virtual scene, an initial location generated by the second virtual character in the virtual scene is the first location, and the first location is used as a location of the second virtual character in the virtual scene, to determine the movement manner of the second virtual character.

For example, a third region is predefined in the virtual scene as the first location, and the initial location generated by the second virtual character in the virtual scene is located in the third region.

In some aspects, the first location is the initial location generated by the second virtual character in the virtual scene. The first location may be determined according to an association relationship between the second virtual character and the first virtual character, for example, may be determined according to intimacy between the second user account and the first user account. A higher intimacy indicates a closer distance between the second virtual character and the first virtual character. For example, the first location may be determined according to the actual distance between the first user account and the second user account. A closer actual distance indicates a closer distance between the second virtual character and the first virtual character.

In some aspects, the first location may be displayed in the virtual scene, or may not display in the virtual scene. For example, the first location may be a third region, such as a “birth island”, displayed in the virtual scene. The third region is distinguished from another region in display styles.

In some aspects, a movement form used by a virtual character that does not exist in the virtual scene may be the same as or different from a movement form of the virtual character that exists in the virtual scene.

For example, the movement form used by the virtual character that does not exist in the virtual scene is different from the movement form of the virtual character that exists in the virtual scene. For example, the movement form used by the virtual character that exists in the virtual scene may be moving by walking, moving by bicycle, or moving by rocket, and the movement form used by the virtual character that does not exist in the virtual scene is moving by spaceship.

In some aspects, regardless of whether the movement form used by the virtual character that does not exist in the virtual scene is different from the movement form used by the virtual character that exists in the virtual scene, a movement speed of the virtual character that does not exist in the virtual scene is determined according to a distance between an initial location generated by the virtual character in the virtual scene and a location of the first virtual character in the virtual scene. For example, if a distance between the initial location generated by the second virtual character in the virtual scene and the first virtual character is within a distance range D1 to D2, a movement speed corresponding to the distance range D1 to D2 is used as the movement speed of the second virtual character. For another example, the movement speed of the second virtual character is determined according to a ratio of the distance between the initial location generated by the second virtual character in the virtual scene and the first virtual character to the time threshold.

According to the foregoing method, in a case that the second virtual character does not exist in the virtual scene, the action animation of the second virtual character transmitting the first information to the first virtual character may also be displayed, thereby reducing the limitation on transmitting the first information in the virtual scene.

The foregoing aspect provides several methods for the first virtual character to receive the first information transmitted by the second virtual character. In addition, this disclosure further provides an aspect in which the first virtual character transmits second information to the third virtual character. The method may further include at least one of the following operation 440 to operation 460.

Operation 440: Display an editing interface of second information in response to a selection operation on a third user account.

The selection operation is an operation configured for selecting the third user account, and the third user account may be different from the first user account and the second user account. The editing interface is an interface configured for editing information. The first user account may edit the first information through the editing interface. The first information may be information being edited by the first user account.

In some aspects, a user account selection interface is displayed in response to an operation on the first virtual character, where the user account selection interface includes at least one candidate user account. The user may select the third user account in the user account selection interface.

For example, the user account selection interface is displayed in response to a fourth operation on the first virtual character, where the user account selection interface includes at least one candidate user account. The editing interface of the second information is displayed in response to the selection operation on the third user account in the candidate user accounts. The fourth operation is configured for triggering to display the user account selection interface, the user account selection interface is configured for selecting the user account, and the fourth operation may include at least one of the following: a click operation, a double-click operation, a slide operation, or a press and hold operation.

In some aspects, before selecting the third user account, the user may further select an information form of the second information.

For example, an information form selection interface is displayed in response to a fifth operation on the first virtual character, where the information form selection interface includes at least one candidate information form. For example, an email form, a text message form, and a social information form are displayed in the information form selection interface. In response to a selection operation on a target form of the candidate information forms, the target form is determined as the information form of the second information, and the target form may be any information form in the information form selection interface. The editing interface of the second information is displayed in response to the selection operation on the third user account in the candidate user accounts. The fifth operation is configured for triggering to display the information form selection interface, the information form selection interface is configured for selecting the information form, and the fifth operation may include at least one of the following: a click operation, a double-click operation, a slide operation, or a press and hold operation.

In some aspects, the user can select the third virtual character in the virtual scene, to perform the selection operation on the third user account.

The selection operation is configured for selecting the virtual character, and the selection operation on the third virtual character is not limited in this disclosure. For example, the selection operation may be a double-click operation, a press and hold operation, a slide operation, or the like on the third virtual character.

For example, the editing interface of the second information is displayed in response to the slide operation pointing from the first virtual character to the third virtual character.

According to the foregoing method, the user can select the third user account by using a single slide operation, which makes the operation interesting and simplifies an operation of selecting the third user account, thereby improving user experience.

Operation 450: Control, in response to a sending operation on the second information, the first virtual character to move toward a third virtual character in the virtual scene, the third virtual character corresponding to the third user account.

Operation 460: In a case that the first virtual character moves to a second region in which the third virtual character is located, display an action animation of the first virtual character transmitting the second information to the third virtual character.

For the movement manner of the first virtual character and the action animation of the first virtual character that are involved in operation 450 and operation 460, reference may be made to the movement manner of the second virtual character and the action animation of the second virtual character in operation 420 to operation 430 in the foregoing aspect, and details are not described in this disclosure again.

In some aspects, in response to the sending operation on the second information, a clone of the first virtual character is controlled to move toward the third virtual character in the virtual scene, while the original body of the first virtual character remains at the original location. If the first user account sends third information to the fourth user account, another clone of the second virtual character is controlled to move toward a fourth virtual character in the virtual scene. The clone may be a copy of the first virtual character. For different information, the first virtual character can be adaptively adjusted to obtain different clones, to distinguish the different information.

In some aspects, the clone of the first virtual character may have or may not have a quantity limit.

In some aspects, if the third user account replies to the second information, the reply information of the third user account to the second information may alternatively be carried and transmitted to the first virtual character by the clone of the first virtual character. The user may send information to a plurality of user accounts in the virtual scene, and may distinguish, according to an image of a virtual character that transmits information, whether the information is information sent by another user account for the first time or reply information to the information sent by the user.

According to the foregoing method, the first user account may also transmit information to another user account in the virtual scene without entering another interface and jumping to another application, thereby simplifying process operations of sending information, reducing complexity of processing information, and improving user efficiency.

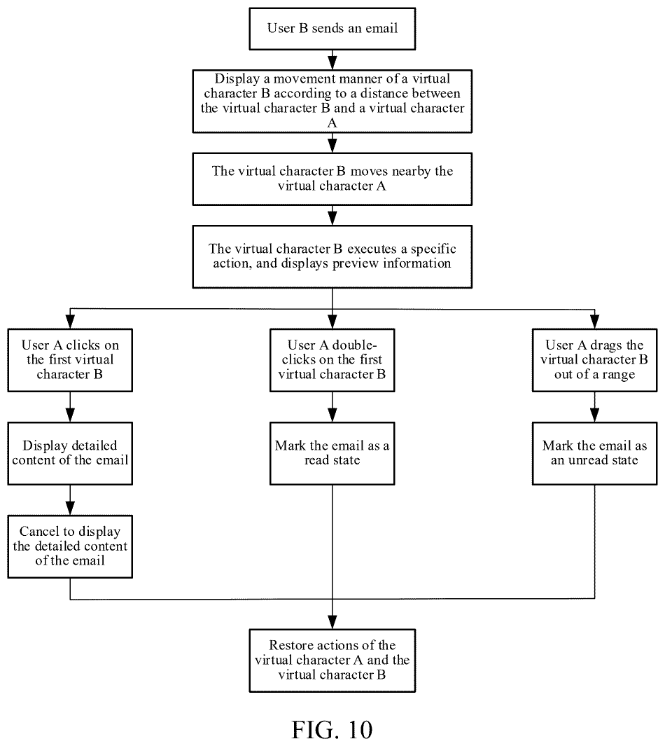

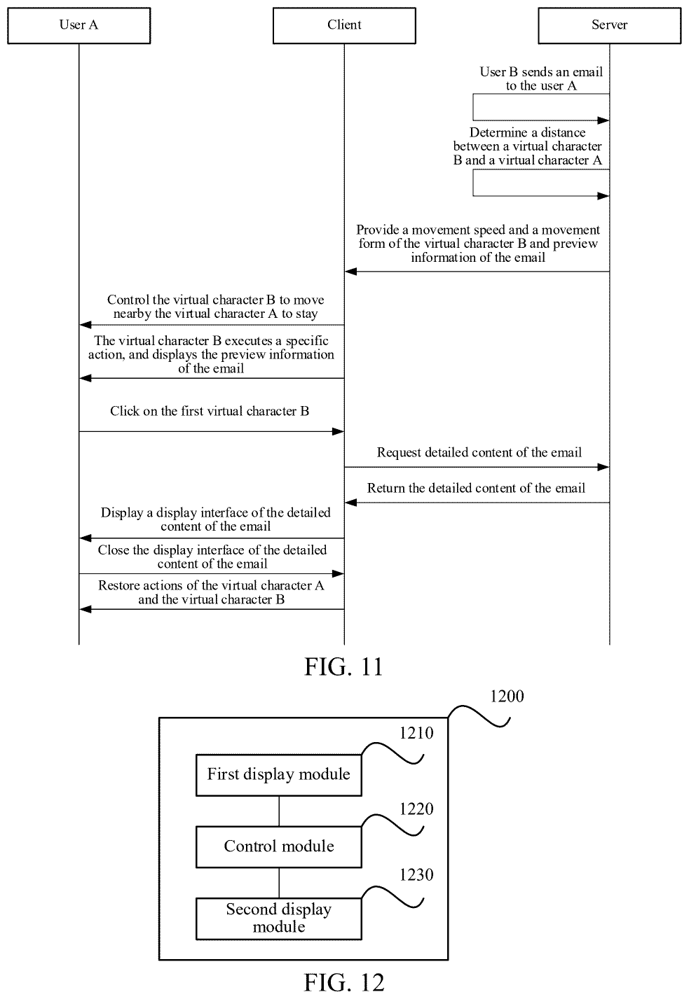

In some aspects, as shown in FIG. 10 and FIG. 11, an example in which a user B sends an email to a user A is used to describe the aspects of this disclosure. The method may be applied to the architecture of the information transmission system shown in FIG. 1.

In a case that it is determined that the user B sends the email to the user A, the server determines a distance between a virtual character B and a virtual character A, where the virtual character A corresponds to the user A, and the virtual character B corresponds to the user B. A movement manner of the virtual character B is determined according to the distance between the virtual character B and the virtual character A, and a movement speed and a movement form of the virtual character B and preview information of the email are sent to the client.

The client controls the virtual character B to move toward the virtual character A. When the virtual character B moves nearby the virtual character A (in a first region of the virtual character A), the client controls the virtual character B to perform a specific action (for example, an action animation of transmitting the email to the virtual character A), and displays the preview information of the email.

In response to a click operation on the virtual character B or the preview information, the client requests detailed content of the email from the server. After receiving the detailed content of the email returned by the server, the client displays the detailed content of the email to the user A. In response to an operation of closing a display interface of the detailed content of the email by the user, the client controls the virtual character A to be displayed in the first default posture, and the virtual character B to be displayed in the second default posture.

Alternatively, in response to a double-click operation on the virtual character B, the client marks the email as a read state, and displays the first prompt information.

Alternatively, in response to a drag operation on the virtual character B (dragging the virtual character B out of the first region in which the virtual character A is located), the client marks the email as an unread state.

The information transmission method provided in this disclosure is more closely and naturally integrated with the virtual world, providing the user with more interesting and more realistic message processing experience. This can enhance the motivation for the user to transmit messages, thereby indirectly improving the frequency of social communication. The interesting message processing manner also increases the user engagement, increasing the user retention in the virtual world.

The following is an apparatus aspect of this disclosure, which can be used to perform the method aspects of this disclosure. For details not disclosed in the apparatus aspect of this disclosure, reference is made to the method aspects of this disclosure.

FIG. 12 is a block diagram of an information transmission apparatus according to an aspect of this disclosure. The apparatus has a function of implementing the foregoing method examples, and the function may be implemented through hardware, or may be implemented in such a manner that the hardware executes related software. The apparatus may be the terminal device described above, or may be arranged in a terminal device. As shown in FIG. 12, the apparatus 1200 includes: a first display module 1210, a control module 1220, and a second display module 1230.

The first display module 1210 is configured to display a display interface of a virtual scene in which a first virtual character is located, the virtual scene including the first virtual character and at least one another virtual character, and the first virtual character corresponding to a first user account.

The control module 1220 is configured to: in a case that the first user account receives first information from a second user account, control a second virtual character to move toward the first virtual character in the virtual scene, the second virtual character corresponding to the second user account.

The second display module 1230 is configured to: in a case that the second virtual character moves to a first region in which the first virtual character is located, display an action animation of the second virtual character transmitting the first information to the first virtual character, and display preview information of the first information.

In some aspects, the control module 1220 is configured to control the second virtual character to move toward the first virtual character in the virtual scene in a first movement manner, the first movement manner being determined according to a distance between the second virtual character and the first virtual character.

In some aspects, the movement manner is related to at least one of the following: a movement speed and a movement form.

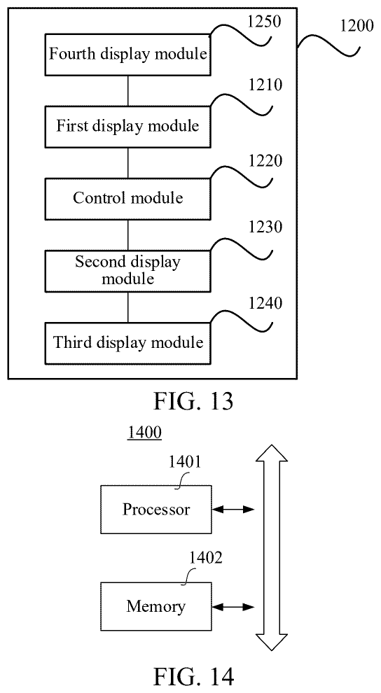

In some aspects, as shown in FIG. 13, the apparatus 1200 further includes a third display module 1240.

The third display module 1240 is configured to display the first information in response to an operation of viewing the first information.

In some aspects, the operation of viewing the first information is: a click operation on the second virtual character or the preview information.

In some aspects, the third display module 1240 is further configured to: mark, in response to an operation of marking the first information as a read state, the first information as the read state, and display first prompt information, the first prompt information being configured for indicating that the first information has been marked as the read state.

In some aspects, the operation of marking the first information as a read state is: a press and hold operation on the second virtual character or the preview information.

In some aspects, as shown in FIG. 13, the third display module 1240 is further configured to mark the first information as an unread state in response to an operation of temporarily not processing the first information.

In some aspects, the operation of temporarily not processing the first information is: a drag operation on the second virtual character or the preview information.

In some aspects, as shown in FIG. 13, the third display module 1240 is further configured to: display, in the virtual scene, the first virtual character in a first default posture and display the second virtual character in a second default posture, the first default posture being different from the second default posture.

In some aspects, as shown in FIG. 13, the apparatus 1200 further includes a fourth display module 1250.

The fourth display module 1250 is configured to: display an editing interface of second information in response to a selection operation on a third user account; control, in response to a sending operation on the second information, the first virtual character to move toward a third virtual character in the virtual scene, the third virtual character corresponding to the third user account; and display an action animation of the first virtual character transmitting the second information to the third virtual character in a case that the first virtual character moves to a second region in which the third virtual character is located.

In some aspects, the selection operation on a third user account is: a slide operation pointing from the first virtual character to the third virtual character.

In some aspects, the control module 1220 is configured to: in a case that the virtual scene does not include the second virtual character, display the second virtual character at a first location in the virtual scene and control the second virtual character to move toward the first virtual character.

According to the technical solutions provided in the aspects of this disclosure, in a case that the first user account receives the first information from the second user account, the action animation of the second virtual character transmitting the first information to the first virtual character and the preview information of the first information are displayed in the display interface of the virtual scene, so that the user can determine the content of the new information according to the preview information without performing other operations, thereby improving the efficiency of viewing the new information.

Further, the user can determine how to process the new information (such as viewing details, ignoring, or replying) according to the preview information, thereby improving the efficiency of processing the new information by the user.

In addition, in a case of processing information in a virtual world, information transmission between user accounts is simulated through virtual characters, so that the real world and the virtual world are more closely and naturally integrated, providing the user with a more interesting and realistic information processing experience. This can stimulate the user's interest in transmitting information, thereby improving the use frequency of the application, increasing the user retention in the virtual world, and further improving the user stickiness to the application. Moreover, this enables the virtual characters to have an information transmission function, thereby enriching the capabilities of the virtual characters and improving the utilization of the virtual characters.

When the apparatus provided in the foregoing aspects implements functions of the apparatus, only division of the foregoing functional modules is used an example for description. In actual application, the foregoing functions may be allocated and completed by different functional modules according to actual requirements, that is, the internal structure of the device is divided into different functional modules, to implement all or some of the functions described above.

For the apparatus in the foregoing aspects, specific manners in which the modules perform operations have been described in further detail in the aspects related to the method, and details are not described herein.

FIG. 14 is a structural block diagram of a terminal device according to another aspect of this disclosure.

The computer device 1400 includes: a processor 1401 (e.g., processing circuitry), and a memory 1402 (e.g., a non-transitory computer-readable storage medium).

The processor 1401 may include one or more processing cores, such as a 4-core processor or an 9-core processor. The processor 1401 may be implemented by using at least one hardware form of a digital signal processing (DSP), a field programmable gate array (FPGA), and a programmable logic array (PLA). The processor 1401 may also include a main processor and a coprocessor. The main processor is a processor configured to process data in an active state, also referred to as a central processing unit (CPU). The coprocessor is a low-power consumption processor configured to process data in a standby state. In some aspects, the processor 1401 may be integrated with a graphics processing unit (GPU). The GPU is configured to be responsible for rendering and drawing content that needs to be displayed on a display screen. In some aspects, the processor 1401 may alternatively include an artificial intelligence (AI) processor. The AI processor is configured to process a computing operation related to machine learning.

The memory 1402 may include one or more computer-readable storage media. The computer-readable storage medium may be tangible and non-transitory. The memory 1402 may alternatively include a high-speed random access memory and a non-volatile memory, for example, one or more disk storage devices and flash storage devices. In some aspects, the non-transitory computer-readable storage medium in the memory 1402 has a computer program stored therein, and the computer program is loaded and executed by the processor 1401 to implement the foregoing information transmission method.

A person skilled in the art may understand that the structure shown in FIG. 14 does not constitute any limitation on the computer device 1400, and the computer device 1400 may include more components or fewer components than those shown in the figure, or some components may be combined, or a different component deployment may be used.

In an aspect, a computer-readable storage medium is further provided. The storage medium has a computer program stored therein, and the computer program, when executed by a processor of a computer device, implements the foregoing information transmission method.

In some aspects, the computer-readable storage medium such as a non-transitory computer-readable storage medium may include: a read-only memory (ROM), a random access memory (RAM), a solid state drives (SSD), an optical disc, or the like. The RAM may include a resistance random access memory (ReRAM) and a dynamic random access memory (DRAM).

In an aspect, a computer program product is further provided. The computer program product includes a computer program, and the computer program is stored in a computer-readable storage medium. A processor of a terminal device reads the computer program from the computer-readable storage medium, and executes the computer program, to cause the terminal device to perform the foregoing information transmission method.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

“A plurality of” mentioned in this specification means two or more. “And/or” describes an association relationship between associated objects and represents that three relationships may exist. For example, A and/or B may represent the following three cases: Only A exists, both A and B exist, and only B exists. The character “/” represents an “or” relationship between the associated objects.

The foregoing descriptions are merely some examples of aspects of this disclosure and are not intended to limit the scope of this disclosure. Any modification, equivalent replacement, or improvement made within the spirit and principle of this disclosure shall fall within the scope of this disclosure.

What is claimed is:

1. An information transmission method, comprising:
displaying a display interface of a virtual scene, the virtual scene including a first virtual character, the first virtual character corresponding to a first user account;
controlling a second virtual character to move toward the first virtual character in the virtual scene to send first information to the first virtual character, the second virtual character corresponding to a second user account; and
based on the second virtual character entering a first region in which the first virtual character is located, displaying (i) a first action animation of the second virtual character sending the first information to the first virtual character, and (ii) preview information of the first information.

2. The method according to claim 1, wherein the controlling the second virtual character comprises:
controlling the second virtual character to move toward the first virtual character in the virtual scene in a first movement manner, the first movement manner being determined based on a distance between the second virtual character and the first virtual character.

3. The method according to claim 2, wherein the first movement manner comprises at least one of a movement speed or a movement form.

4. The method according to claim 1, further comprising:
displaying the first information in response to a viewing operation.

5. The method according to claim 4, wherein the viewing operation comprises: a click operation on at least one of the second virtual character and the preview information.

6. The method according to claim 1, further comprising:
marking the first information as in a read state in response to a marking operation; and
displaying first indication information indicating the first information has been marked as in the read state.

7. The method according to claim 6, wherein the marking operation comprises: a press and hold operation on at least one of the second virtual character or the preview information.

8. The method according to claim 1, further comprising:
marking the first information as in an unread state in response to a deferral operation.

9. The method according to claim 8, wherein the deferral operation comprises: a drag operation on at least one of the second virtual character or the preview information.

10. The method according to claim 1, further comprising:
displaying the first virtual character in a first default pose in the virtual scene; and
displaying the second virtual character in a second default pose in the virtual scene, the first default pose being different from the second default pose.

11. The method according to claim 1, further comprising:
displaying an editing interface of second information in response to a selection operation on a third user account;
controlling the first virtual character to move toward a third virtual character in the virtual scene, the third virtual character corresponding to the third user account; and
when the first virtual character enters a second region in which the third virtual character is located, displaying a second action animation of the first virtual character sending the second information to the third virtual character.

12. The method according to claim 11, wherein the selection operation comprises: a slide operation extending from the first virtual character to the third virtual character.

13. The method according to claim 1, wherein the controlling the second virtual character to move toward the first virtual character comprises:
when the virtual scene does not include the second virtual character, displaying the second virtual character at an initial location in the virtual scene and controlling the second virtual character to move from the initial location toward the first virtual character.

14. An information processing apparatus, comprising:
processing circuitry configured to:
display a display interface of a virtual scene, the virtual scene including a first virtual character, the first virtual character corresponding to a first user account;
control a second virtual character to move toward the first virtual character in the virtual scene to send first information to the first virtual character, the second virtual character corresponding to a second user account; and
based on the second virtual character entering a first region in which the first virtual character is located, display (i) a first action animation of the second virtual character sending the first information to the first virtual character, and (ii) preview information of the first information.

15. The apparatus according to claim 14, wherein the processing circuitry is configured to:
control the second virtual character to move toward the first virtual character in the virtual scene in a first movement manner, the first movement manner being determined based on a distance between the second virtual character and the first virtual character.

16. The apparatus according to claim 15, wherein the first movement manner comprises at least one of a movement speed or a movement form.

17. The apparatus according to claim 14, wherein the processing circuitry is configured to:
display the first information in response to a viewing operation.

18. The apparatus according to claim 17, wherein the viewing operation comprises a click operation on at least one of the second virtual character and the preview information.

19. The apparatus according to claim 14, wherein the processing circuitry is configured to:
mark the first information as in a read state in response to a marking operation; and
display first indication information indicating the first information has been marked as in the read state.

20. A non-transitory computer-readable storage medium storing instructions which, when executed by a processor, cause the processor to perform:
displaying a display interface of a virtual scene, the virtual scene including a first virtual character, the first virtual character corresponding to a first user account;
controlling a second virtual character to move toward the first virtual character in the virtual scene to send first information to the first virtual character, the second virtual character corresponding to a second user account; and
based on the second virtual character entering a first region in which the first virtual character is located, displaying (i) a first action animation of the second virtual character sending the first information to the first virtual character, and (ii) preview information of the first information.
